(19) United States
(12) Patent Application Publication
(10) Pub. No.: US 2013/0099560 A1
(43) Pub. Date: Apr. 25, 2013

(54) MULTIPLE SOURCE ELECTRICAL POWER DISTRIBUTION IN AIRCRAFT

(71) Applicant: GE AVIATION SYSTEMS LIMITED, Gloucestershire (GB)

(72) Inventors: Adrian SHIPLEY, Cheltenham (GB); Simon J. LINACRE, Chelteham (GB); Victor BONNEAU, Dayton, OH (US)

(73) Assignee: GE AVIATION SYSTEMS LIMITED, Gloucestershire (GB)

(21) Appl. No.: 13/658,178

(22) Filed: Oct. 23, 2012

(30) Foreign Application Priority Data
Oct. 24, 2011 (GB) 1118314.2

(51) Int. Cl. B64D 33/00

(52) U.S. Cl. 307/9.1

(57) ABSTRACT

Disclosed herein is a method of providing electrical power to an aircraft. The method comprises selectively sourcing power from a plurality of power sources. The power sources comprise one or more generators driven by an engine, and at least one other power source comprising one or more batteries, one or more fuel cells and/or one or more thermo-electric power sources.

### BACKGROUND OF THE INVENTION

Embodiments of the present invention relate to electrical power distribution systems for aircraft and methods of providing electrical power to aircraft systems.

Traditionally, to provide electrical power to essential and non-essential electrical loads, aircraft have relied on generators that are driven by the propelling gas turbine engines and in some cases on an auxiliary power unit (APU), which generates power independently of the generators. In the event of failure of these systems, a “ram air turbine” (RAT) has been used to maintain power to the essential aircraft loads. Essential aircraft loads include the avionics systems, for example, and any other flight-critical equipment. Non-essential aircraft loads include cabin lighting, food preparation and entertainment systems, for example, and other equipment that is not flight-critical. The RAT comprises a turbine/propeller that is retractably releasable from the under-carriage of the aircraft to extend into the external airflow to be driven thereby and thus drive a generator. RATs are inefficient because almost all of the time, they are not utilized, yet they add weight to the aircraft. Additionally, functionality testing of the RAT is required by annually performing a test flight without passengers on-board. Both RATs and APUs are inefficient ways of generating power and there is a need to reduce consumption of aviation fuel wherever possible, due to environmental and cost considerations.

### BRIEF DESCRIPTION OF THE INVENTION

An embodiment of the invention provides a method of providing electrical power to an aircraft. The method comprises selectively sourcing power from a plurality of power sources, the power sources comprising one or more generators driven by an engine, and at least one other power source comprising one or more batteries, one or more fuel cells and/or one or more thermo-electric power sources.

Further, an embodiment of the invention provides an electrical power distribution system for an aircraft. The electrical power distribution system comprises a plurality of power sources comprising one or more engine-driven generators, and at least one other power source comprising one or more batteries, one or more fuel cells and/or one or more thermo-electric power sources. The electrical power distribution system further comprises an electrical power bus connecting the plurality electrical power sources to loads of the aircraft, and a controller configured to selectively source power from each of the plurality of power sources.

### BRIEF DESCRIPTION OF THE DRAWINGS

There follows a detailed description of embodiments of the invention by way of example only with reference to the accompanying drawings, in which:

FIG. 1 is a schematic diagram illustrating the structure of an embodiment of a power distribution system; and

FIG. 2 shows an alternative embodiment of the power distribution system shown in FIG. 1.

### DETAILED DESCRIPTION OF THE DRAWINGS

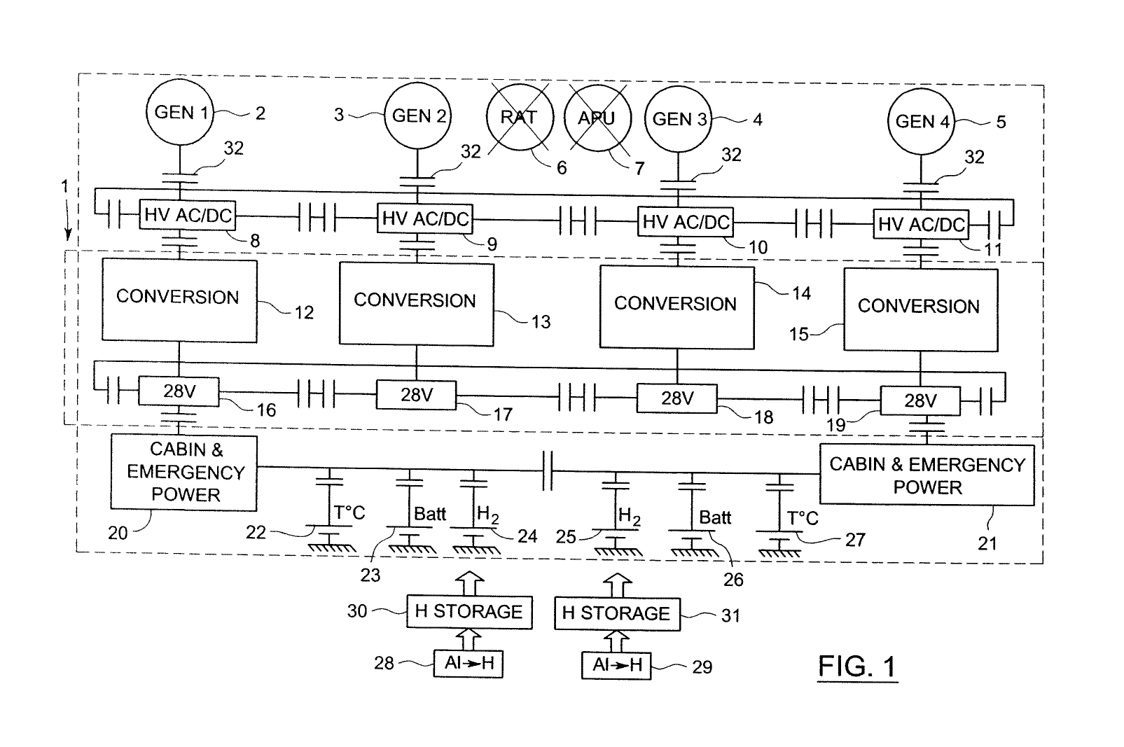

FIG. 1 shows schematically an aircraft power distribution system 1 including four generators 2,3,4,5 which are driven independently of one another by the engines of the aircraft. Generally, one generator per engine is used. The output of each generator 2,3,4,5 is connected to a corresponding local high voltage power bus 8,9,10,11. The generators produce a high voltage AC or DC current which needs to be converted to an appropriate level for operating the cabin and emergency power systems of the aircraft. The pair of opposed parallel lines 32 shown in FIG. 1 and throughout the drawings schematically indicate switches for establishing an electrical connection between the various components of the system. In one embodiment of the invention, at least one high voltage power bus 8,9,10,11 is provided per generator, rather than one high power bus for all of the generators. In this way, greater redundancy is provided since the system is not reliant upon only one high power bus. The high voltage power buses are each connected to conversion means 12,13,14,15 which reduce the voltage to 28V and the conversion means are connected to a local low voltage power bus 16,17,18,19. Again, greater redundancy is achieved by providing one low voltage power bus for each conversion means 12,13,14,15. From the low voltage power buses 16,17,18,19, electrical current passes to one or more cabin and emergency power buses 20,21 for distributing power throughout the cabin and for operating emergency systems. The power distribution system 1 has a plurality of different power sources, including not only the engine-driven generators 2,3,4,5, but also at least one of thermal electrical generation means 22,27, electrical storage means 23,26 comprising batteries and fuel cells 24,25. In a further aspect, the fuel cells are powered by hydrogen produced using an Aluminium catalyst 28,29 which allows on-board production of hydrogen from aviation fuel. The hydrogen is stored in hydrogen storage containers 30,31. The storage capacity is chosen based on the rate of production of hydrogen by the catalysis of fuel.

The thermal electrical generation means are shown and described in a co-pending British patent application in the name of GE Aviation Systems Ltd and having an application reference of 249731/16389, the disclosure of which is incorporated herein by reference. This source of power comprises an array of thermocouples mounted on the exhaust section of the engines which utilize waste exhaust heat that would otherwise be discarded.

As shown by the reference numerals 6 and 7, the RAT and the APU have been eliminated, as they are no longer required.

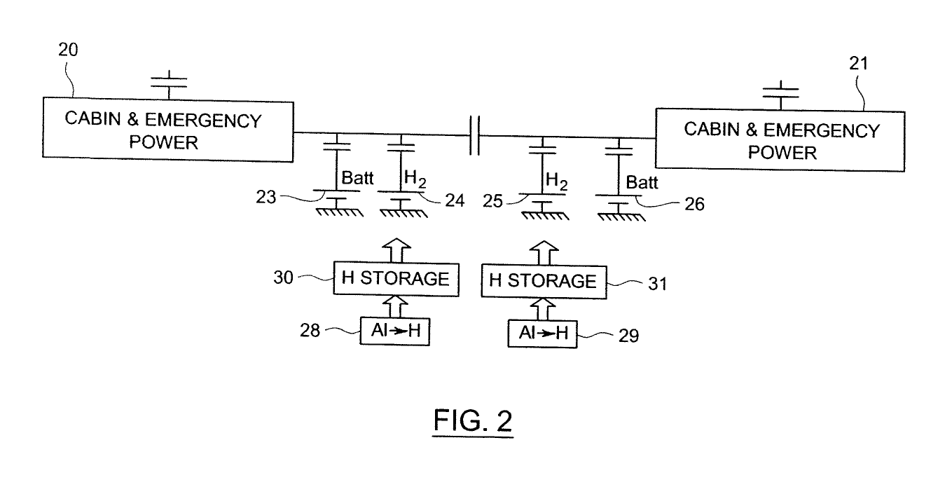

In the embodiment shown in FIG. 2, a combination of batteries 23,26 and first and second fuel cells 24,25 is relied upon, without the thermal electrical generation means. The fuel cells 24,25 are appropriate for approximately 3 hours of operation or the duration of the flight, whichever is longer. By providing a pair of fuel cells, dual redundancy is ensured allowing safety critical power performance and again, the RAT and APU are not required. The batteries 23,26 may be used to provide fill-in power during fuel cell start up.

The selective sourcing or co-ordination of power from an appropriate one or more of the power sources is controlled by a controller of the power distribution system. Under normal conditions, power is derived from the fuel cells, the batteries and/or the thermo-electric power sources in any desired combination. Under normal conditions, the choice of power source can be made so as to maximize the efficiency of the power distribution system, i.e. minimize fuel usage. Fuel cells produce water in operation, which in accordance with an embodiment of the invention, can be used in the toilet and hand wash facilities of the aircraft. This correspondingly allows a reduction in the amount of water carried at take-off. The fuel cells and the thermo-electric power source are thus preferred means of deriving power in normal operation, so that water can be generated while at the same time taking advantage of the efficiency of the thermo-electric power source.

The relative power levels producible by each of the power sources is roughly 90-120 kW per engine-driven generator, 15-30 kW per fuel cell, 15 kW per battery (approx. ½ hour life) and 70 kW per engine through thermoelectric waste heat generation.

Under emergency conditions, power is diverted to essential loads away from non-essential loads. The power distribution system described herein can be retrofitted to existing aircraft whereby the RAT and APU can be removed. Embodiments of the invention are also compatible with aircraft in which one or both of the RAT and APU are retained, in which case, the power distribution system would provide high levels of redundancy and hence safety.

What is claimed is:

1. A method of providing electrical power to an aircraft, the method comprising selectively sourcing power from a plurality of power sources, the power sources comprising one or more generators driven by an engine, and at least one other power source comprising one or more batteries, one or more fuel cells, and/or one or more thermo-electric power sources.

2. The method according to claim 1, further comprising diverting power to essential loads away from non-essential loads under emergency conditions.

3. The method according to claim 1, wherein the plurality of power sources further comprises an auxiliary power unit.

4. The method according to claim 1, comprising selectively sourcing power from each of the plurality of power sources to minimize an overall consumption of aviation fuel under non-emergency conditions.

5. The method according to claim 4, wherein the at least one other power source is one or more thermo-electric power sources, and wherein the one or more thermo-electric power sources are used as the primary source of power under non-emergency conditions.

6. The method according to claim 4, wherein the at least one other power source is one or more fuel cells, and wherein the one ore more fuel cells are used as the primary source of power under non-emergency conditions.

7. The method according to claim 1, further comprising using the at least one other power source in the event of failure of the generators.

8. The method according to claim 1, wherein power is sourced from two or more of the plurality of power sources simultaneously.

9. The method according to claim 1, wherein power is sourced from all of the plurality of power sources simultaneously.

10. The method according to claim 1, further comprising using water produced by the at least one other power source in a cabin of the aircraft.

11. An electrical power distribution system for an aircraft, the electrical power distribution system comprising:
a plurality of power sources comprising one or more engine-driven generators, and at least one other power source comprising one or more batteries, one or more fuel cells and/or one or more thermo-electric power sources;
an electrical power bus connecting the plurality of electrical power sources to loads of the aircraft; and
a controller configured to selectively source power from each of the plurality of power sources.

12. The power distribution system according to claim 12, wherein the controller is configured to divert power to essential loads away from non-essential loads under emergency conditions,.

13. The power distribution system according to claim 12, wherein the controller is configured to selectively source power from each power source to minimize an overall consumption of aviation fuel under non-emergency conditions.

14. The power distribution system according to claim 12, wherein the primary source of power under non-emergency conditions is one or more of the thermo-electric power sources and the fuel cells.

15. The power distribution system according to claim 12, wherein the controller is configured to source power from one or more of the plurality of power sources simultaneously.
